(19) United States
(12) Patent Application Publication
(10) Pub. No.: US 2014/0157196 A1
(43) Pub. Date: Jun. 5, 2014

(54) ELECTRONIC DECISION SYSTEM AND DECISION METHOD

(71) Applicant: INSTITUTE FOR INFORMATION INDUSTRY, Taipei (TW)

(72) Inventor: Cheng-Yuan HO, Taipei City (TW)

(73) Assignee: INSTITUTE FOR INFORMATION INDUSTRY, Taipei (TW)

(21) Appl. No.: 13/713,692

(22) Filed: Dec. 13, 2012

(30) Foreign Application Priority Data
Dec. 4, 2012 (TW) 101145390

(51) Int. Cl. G06F 3/0482

(52) U.S. Cl. CPC G06F 3/0482
USPC 715/811

(57) ABSTRACT

An electronic decision system is provided. The electronic decision system has: an interaction apparatus configured to display a graphical interface, thereby retrieving multiple option values selected by a user; a database; and a decision module configured to retrieve at least one historical option value corresponding to the user and the multiple option values, wherein the decision module further determines a determination result according to the multiple option values, the at least one historical option value, and the at least one scenario criterion, and displays the determination result on the graphical interface of the interaction apparatus.

### CROSS REFERENCE TO RELATED APPLICATIONS

This Application claims priority of Taiwan Patent Application No. 101145390, filed on Dec. 4, 2012, the entirety of which is incorporated by reference herein.

### BACKGROUND OF THE INVENTION

1. Field of the Invention

The present invention relates to an electronic system, and in particular, to an electronic system capable of referencing historical behavior information of users and/or considering current scenario criteria.

2. Description of the Related Art

With enhancements in the quality of life of humans, more customized and personalized electronic decision systems are being used. However, contents of services (e.g. electronic content) in conventional electronic decision systems are mostly fixed, such as travel schedules and menus. In addition, the range of the electronic content in conventional electronic decision systems and current scenario criteria can not be changed. When selecting preference options of preferred products or services on a conventional electronic decision system, a user can not adjust the preferred contents freely. Thus, it is difficult for the user to determine whether the final result or details of the customized products or services are appropriate or not. In view of this, there is a demand for an electronic decision system, which may provide products or services which more closely resembles the needs of users for specific scenarios, with appropriate limitations.

### BRIEF SUMMARY OF THE INVENTION

A detailed description is given in the following embodiments with reference to the accompanying drawings.

In an exemplary embodiment, an electronic decision system is provided. The electronic decision system has: an interaction apparatus configured to display a graphical interface, thereby retrieving multiple option values selected by a user; a database; and a decision module configured to retrieve at least one historical option value corresponding to the user and the multiple option values, wherein the decision module further determines a determination result according to the multiple option values, the at least one historical option value, and at least one scenario criterion, and displays the determination result on the graphical interface of the interaction apparatus.

In another exemplary embodiment, a decision method applied in an electronic decision system is provided. The decision method comprises the following steps of: retrieving multiple option values of a user from a graphical interface displayed on an interaction apparatus of the electronic decision system; retrieving at least one historical option value corresponding to the user and the multiple option values from a database; determining a determination result according to the multiple option values, the at least one historical option value, and at least one scenario criterion; and displaying the determination result on the graphical interface of the interaction apparatus.

### BRIEF DESCRIPTION OF THE DRAWINGS

The present invention can be more fully understood by reading the subsequent detailed description and examples with references made to the accompanying drawings, wherein:

FIG. 1A is a schematic diagram illustrating an electronic decision system 100 according to an embodiment of the invention;

FIG. 1B is a schematic diagram illustrating the electronic decision system 100 according to another embodiment of the invention;

FIG. 2 is a diagram illustrating the operation of the electronic decision system 100 according to a first specific scenario according to an embodiment of the invention;

FIG. 3 is a flow chart illustrating the operation of the electronic decision system 100 according to a second scenario according to an embodiment of the invention;

FIGS. 4A˜4E are diagrams illustrating the operation of the electronic decision system 100 in the second scenario according to another embodiment of the invention; and

FIG. 5 is a flow chart illustrating a decision method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

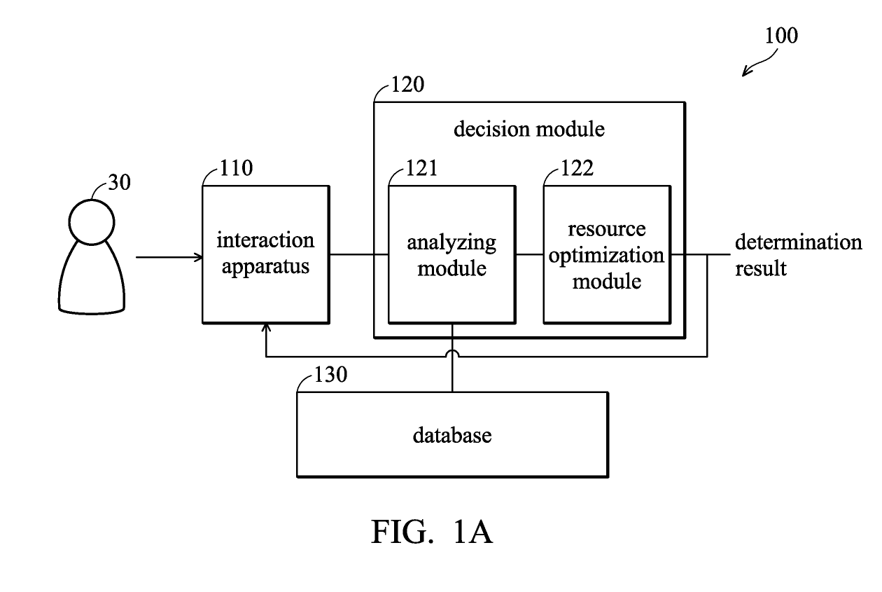

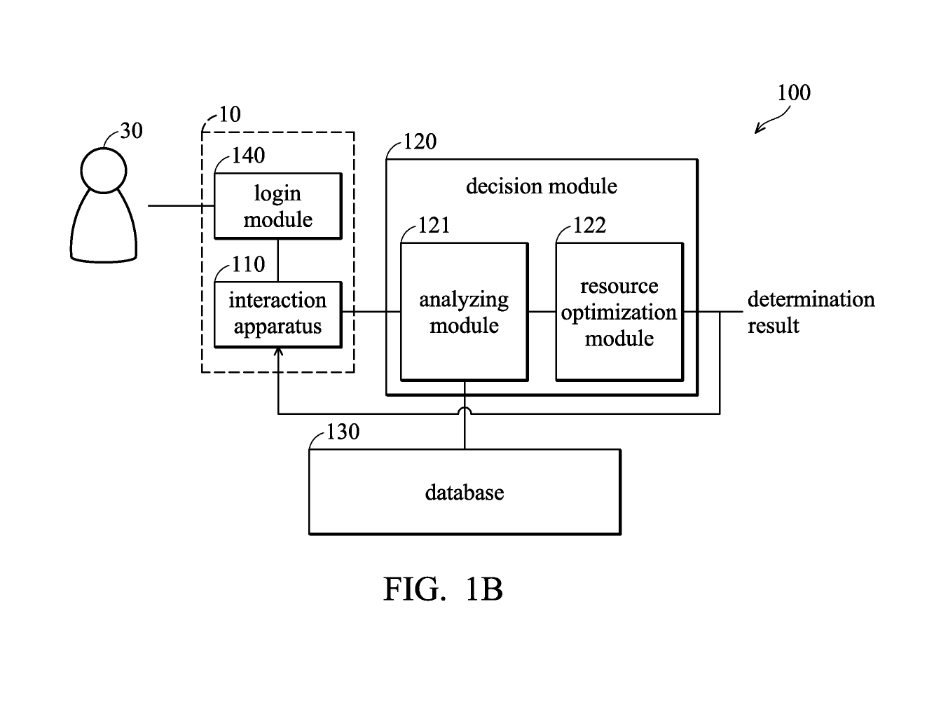

FIG. 1A is a schematic diagram illustrating an electronic decision system 100 according to an embodiment of the invention. In an embodiment, the electronic decision system may comprise an interaction apparatus 110, a decision module 120 and a database 130. The electronic decision system 100 may be applied to different scenarios with an appropriate design. For example, the electronic decision system 100 can be applied to scenarios, such as arranging menus (including the order of dishes), scheduling travel routes, customizing and ordering commercial products, and arranging a multimedia playlist. It should be noted that the aforementioned scenarios are only descriptive examples, and the electronic decision system 100 is not limited to the aforementioned scenarios.

The interaction apparatus 110 is configured to receive feedback information from a user, and transmit the feedback information to the decision module 120. For example, the interaction apparatus 110 may be a touch-sensitive screen or a mobile device (e.g. a smart phone or a tablet PC), but the invention is not limited thereto. The feedback information may be individual preference settings (e.g. food preferences or taste preferences) for a specific scenario (e.g. arranging menus) selected from the interaction apparatus 110 by a user 30. Further, the individual preference settings corresponding to each user may be stored in the database 130. The decision module 121 may comprise an analyzing module 121 and a resource optimization module 122. The analyzing module 121, connected between the interaction apparatus 110 and the database 130, is configured to retrieve option data and at least one historical option value from the database 130, and display the option data on a graphical interface of the interaction apparatus 110. The resource optimization module 122 is configured to determine a determination result according to the option values, the historical option values and the at least one scenario criterion, and display the determination result on the graphical interface of the interaction apparatus 110. Details will be described later.

FIG. 1B is a schematic diagram illustrating the electronic decision system 100 according to another embodiment of the invention. Further, referring to both FIGS. 1A and 1B, the difference between FIGS. 1A and 1B is that the electronic decision system 100 in FIG. 1B further comprises a login module 140 configured to recognize the identity of a user who logs into the electronic decision system 100. Then, the analyzing module 121 may retrieve the historical option values (i.e. the stored preference settings) corresponding to the recognized identity of the user from the database 130. The resource optimization module 122 may perform a resource optimization process on the option values, the historical values and the at least one scenario criterion to determine a determination result.

In addition, the electronic decision system 100 may further be divided into a client terminal 10 and a server terminal. Referring to FIGS. 1A and 1B, the interaction apparatus 110 in FIG. 1A can be integrated into the client terminal 10, as well as the decision module 120 and the database 130 can be integrated into the server terminal. In FIG. 1B, the login module 140 and the interaction apparatus 110 can be integrated into the client terminal 10, as well as the decision module and the database can be integrated into the server terminal. A wired/wireless network or a communications network can be used for communication between the client terminal 10 and the server terminal. For example, the client terminal may be a smart phone or a tablet PC, and the server terminal may be a PC or a server in the embodiment. In another embodiment, the interaction apparatus 110, the decision module 120 and the database 130 in FIG. 1A can be integrated into an electronic device. In addition, the login module 140, the interaction apparatus 110, the decision module 120 and the database 130 in FIG. 1B can also be integrated into an electronic device. In the embodiment, the electronic decision system 100 does not comprise either the client terminal 10 or the server terminal. For example, the interaction apparatus 110 may be a touch-sensitive screen configured to receive a plurality of option values inputted by the user from the graphical interface in the embodiment, and the other components in the electronic decision system 100 may be executed by a processor.

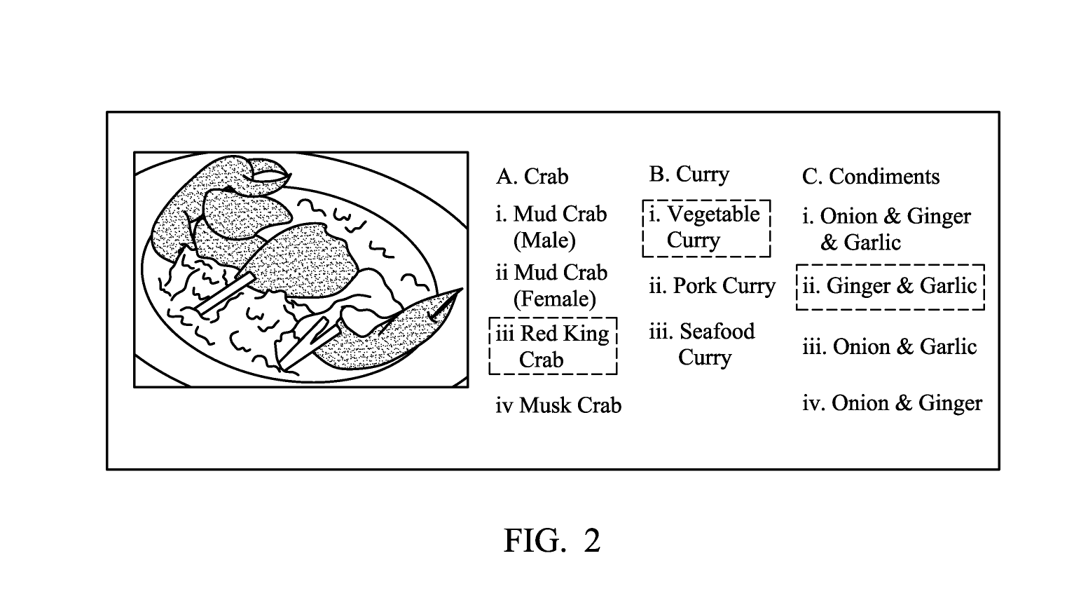

FIG. 2 is a diagram illustrating the operation of the electronic decision system 100 according to a first specific scenario according to an embodiment of the invention. Taking a scenario, such as arranging dishes in a menu, for example, when a user selects a dish named “Crab with Golden Curry” from the interaction apparatus 110, the analyzing module 121 may determine whether individual preference settings of the user corresponding to the dish named “Crab with Golden Curry” and the number of remaining ingredients are stored in the database 130. If so, the analyzing module 121 may retrieve the individual preference settings of the user corresponding to the dish named “Crab with Golden Curry” from the database 130, such as the options for choosing remaining ingredients of main courses, side-dishes, and condiments (not limited). Then, the analyzing module 121 may display the pre-stored option values on the interaction apparatus 110, such as the main course option “Red King Crab”, the side-dish option “Vegetable Curry”, and the condiment option “Ginger & Garlic”. The user may also select other main course options, side-dish options, and condiment options (i.e. manually inputted by the user) freely from the interaction apparatus 110. It should be noted that if some ingredients are unavailable, the analyzing module 121 may not display the unavailable ingredients on the interaction apparatus 110.

Whenever the user alternates the aforementioned options, the analyzing module 121 may also alternate the dish picture and the price thereof displayed on the interaction apparatus, correspondingly. When the main course option, the side-dish option, and the condiment option are confirmed by the user, the analyzing module 121 may further display more options to ask the user about preferred requirements, such as option A: “Break Down Degree of the Crab Shell” and option B: “Pungency Degree” (e.g. not spicy, mild, medium, hot, extra hot, and super hot). When the options of preferred requirements are confirmed by the user from the interaction apparatus 110, the resource optimization module 122 may perform a resource optimization process according to the currently selected options of the user, thereby calculating the final price of the selected dish “Crab with Golden Curry”. Then, the resource optimization module 122 may selectively transmit the result after resource optimization to the support crews (e.g. chefs), thereby allocating requirements of the user.

In the embodiment, if the individual preference settings of the user corresponding to the dish named “Crab with Golden Curry” are not stored in the database 130, the analyzing module 121 may still display all of the available options of the main courses, side-dishes, and condiments on the interaction apparatus 110, and the user may still select the desired options freely. Then, the subsequent actions of the electronic decision system 100 are the same with those described in the aforementioned embodiments. Thus, detailed descriptions will be omitted hereafter.

In another embodiment, the analyzing module 121 may further filter appropriate dish options (e.g. options of main courses, side-dishes, and condiments) to be displayed according to the stored data, such as individual historical behaviors, medical records, physical characteristics, or the religious faith of the user. For example, when the user has a medical record of diabetes, the analyzing module 121 may filter out dishes with too much sugar, fat or salt. In addition, when the user is a Muslim, the analyzing module 121 may filter out dishes having pork. When the user does not like a specific ingredient (e.g. coriander leaves or gingers), the analyzing module 121 may filter out dishes having the specific ingredient or filter out options of the specific ingredient. Further, the analyzing module 121 may further retrieve the number of each remaining ingredient. When a specific ingredient is unavailable, the analyzing module 121 may filter out options of the specific ingredient or dishes having the specific ingredient as a main course. It should be noted that the aforementioned embodiments are used to describe the possible implementation manners. It is appreciated for those skilled in the art that the invention is not limited to the aforementioned embodiments.

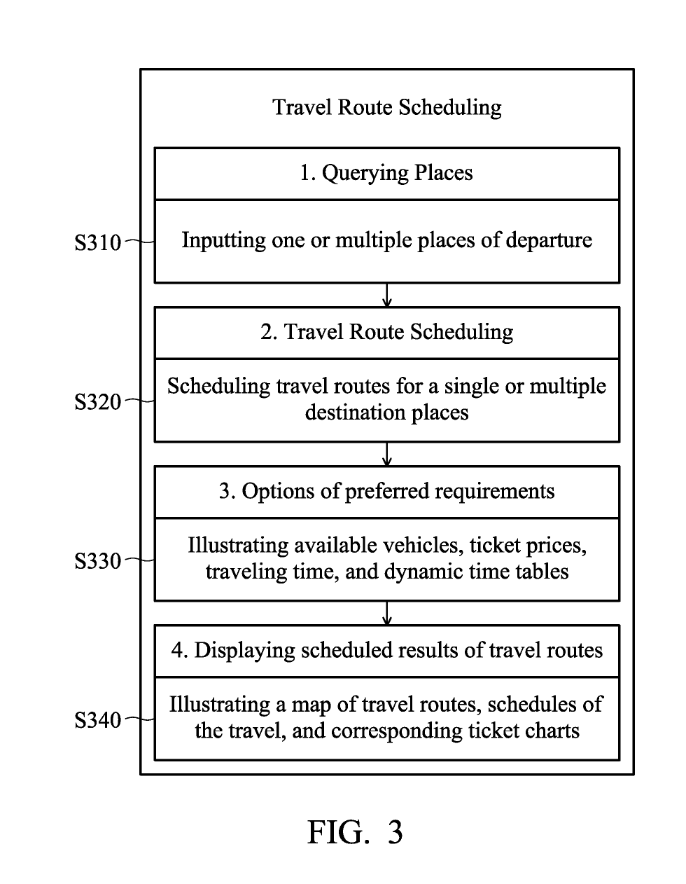

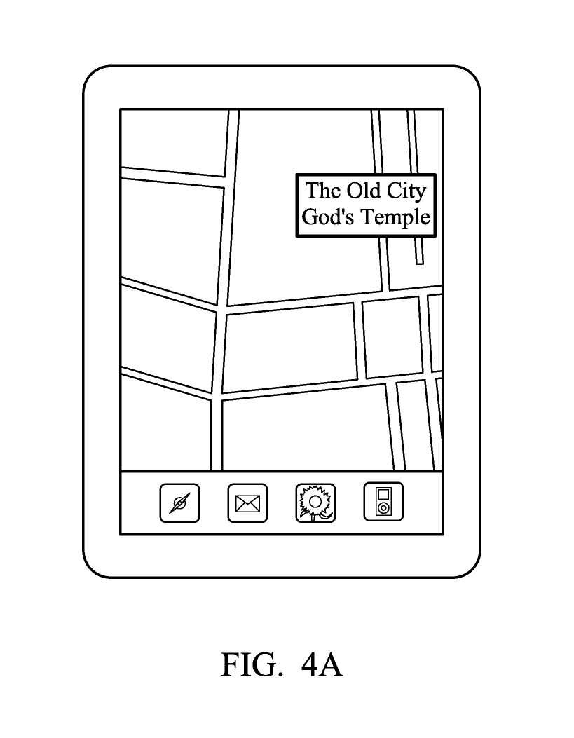

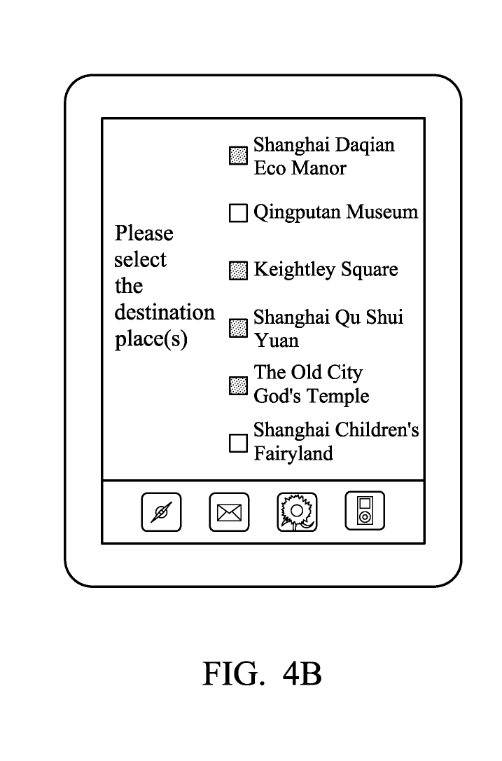

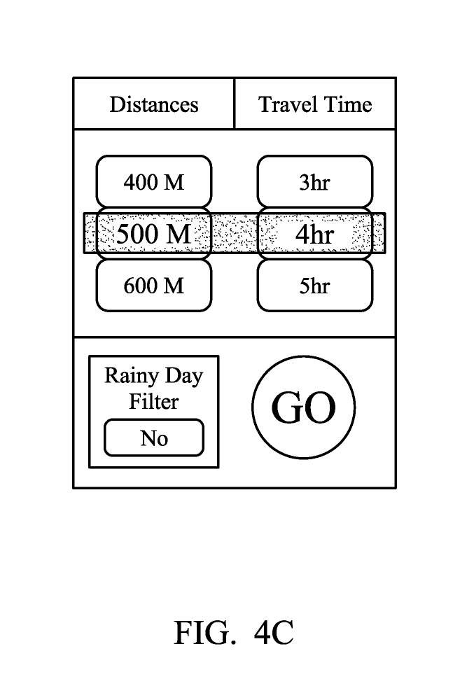

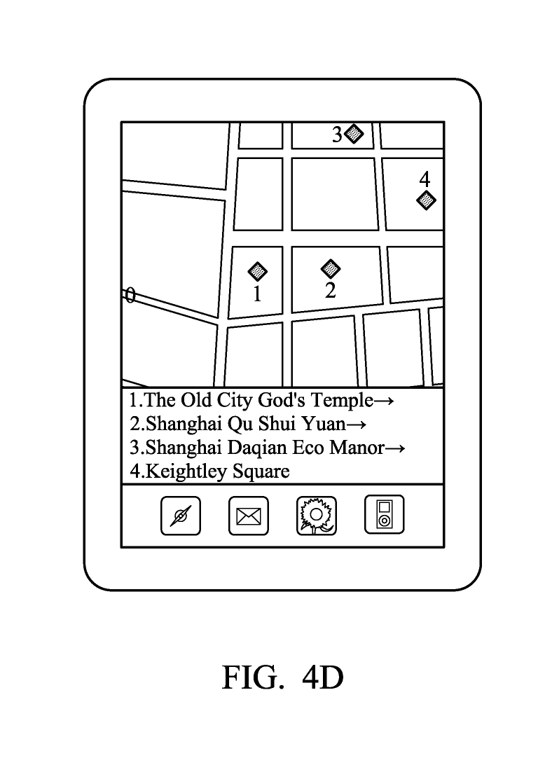

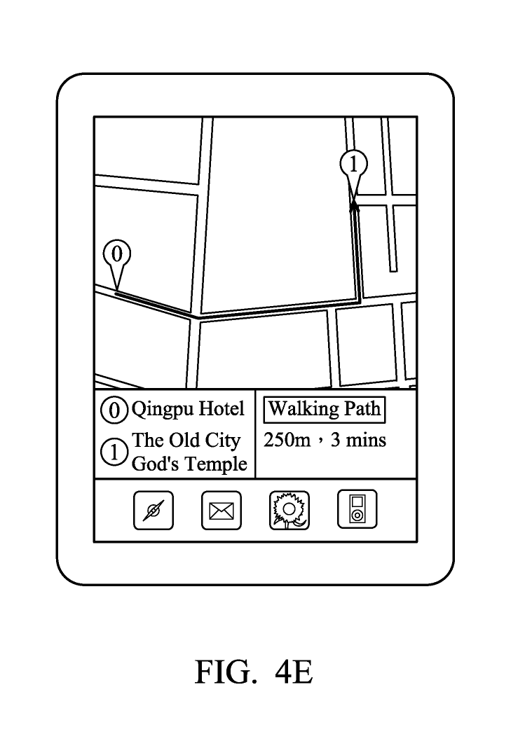

FIG. 3 is a flow chart illustrating the operation of the electronic decision system 100 according to a second scenario according to an embodiment of the invention. FIGS. 4A˜4E are diagrams illustrating the operation of the electronic decision system 100 in the second scenario according to another embodiment of the invention. In another embodiment, the electronic decision system 100 may be configured to schedule travel routes. Referring to FIG. 3 and FIGS. 4A˜4E, for example, a user may query various scenic spots via the electronic decision system 100 (step S310), as illustrated in FIG. 3. Further, the user may use the interaction apparatus 110 to input one or more places of departure to the decision module 120 for query, as illustrated in FIG. 4A. Then, the analyzing module 121 may display multiple candidate destinations for travel route scheduling (step S320), so that the user may select one or more destination places by the interaction apparatus 110. As illustrated in FIG. 4B, the candidate destination places with black columns are the destination places selected by the user. After determining the places of departure and the destination places, the analyzing module 121 may further display options for preferred requirements, such as travel time, vehicles, distances, or weather conditions (not limited), on the interaction apparatus 110 (step S330), as illustrated in FIG. 4C. After the options for preferred requirements are confirmed by the user from the interaction apparatus 110, the resource optimization module 122 may integrate the inputted options to perform a resource optimization process, and display the results after the resource optimization process (step S340), such as a travel map, a schedule and a table of corresponding ticket prices (not limited). As illustrated in FIG. 4D, the place 0 may indicate the place of departure (e.g. Qingpu Hotel) inputted by the user, and the places 1˜4 may indicate the scheduled order of the destination places inputted by the user after the resource optimization process. For example, the scheduled order of the destination places may be 1. “The Old City God's Temple”, 2. “Shanghai Qu Shui Yuan”, 3. “Shanghai Daqian Eco Manor”, and 4. “Keightley Square”. Further, FIG. 4E is a diagram illustrating the enlarged travel route between the place 0 “Qingpu Hotel” to the place 1 “The Old City God's Temple”. It should be noted that the places of departure and the destination places inputted by the user may be regarded as option values inputted by the user. The decision module 120 may also integrate individual historical option values of the user, weather conditions, current traffic conditions, or the crowds to perform the resource optimization process in the aforementioned embodiments. For example, if the user had used the electronic decision system 100 to schedule travel routes or set individual preference settings corresponding to the scheduling travel routes, the decision module 120 may make a determination result by referring to the historical option values of the user.

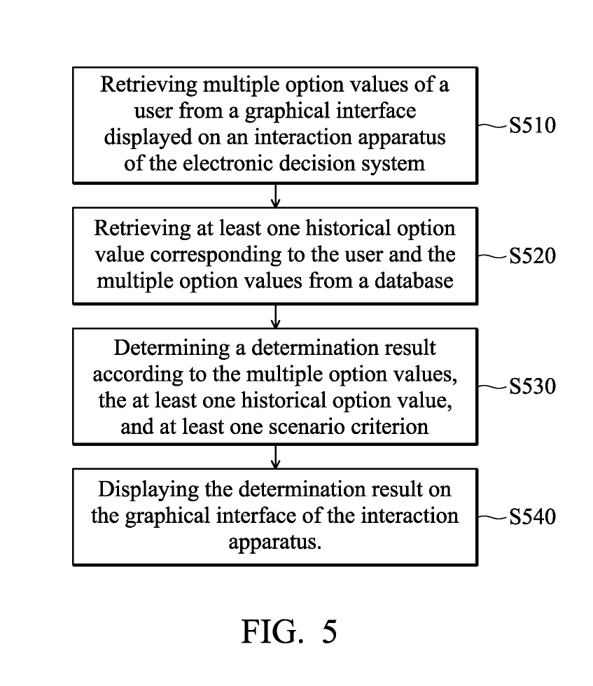

FIG. 5 is a flow chart illustrating a decision method according to an embodiment of the invention. In step S510, the analyzing module 121 may retrieve multiple option values (e.g. options of main courses, side-dishes, and condiments in FIG. 2, or places of departure and destination places in FIG. 3) selected by a user from a graphical interface displayed on the interaction apparatus 110. In step S520, the analyzing module 121 may retrieve at least one historical option value of the user (e.g. individual preference settings of the user stored in the database 130, such as historical behaviors, medical records, or religious faith) corresponding to the multiple option values from the database 130. In step S530, the resource optimization module 122 may determine a determination result according to the multiple option values, the historical option values, and the at least one scenario criterion (e.g. types and numbers of ingredients, weather condition, or traffic). In step S540, the resource optimization module 122 may display the determination result on a graphical interface of the interaction apparatus 110. Then, the user may quickly know the determination result fitting his/her needs from the graphical interface. It should be noted that the options for preferred requirements provided by the analyzing module 121 may also be used by the resource optimization module 122. That is, the resource optimization module 122 may determine a determination result according to the option values, historical option values, the scenario criteria, and the options for preferred requirements.

In view of the above, the electronic decision system of the invention may illustrate a graphical interface, so that a user may select preferred options freely and know the determination result easily by using the graphical interface. In addition, the electronic decision system of the invention may determine a determination result according to individual historical option values of the user and the at least one scenario criterion, so that the determination result more closely reflects the requirements of users. Furthermore, the electronic decision system of the invention can be applied to services, such as scheduling travel routes, arranging menus, arranging multimedia playlists, or customizing and ordering commercial products, but the invention is not limited thereto.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic decision system, comprising:
an interaction apparatus configured to display a graphical interface, thereby retrieving multiple option values selected by a user;
a database; and
a decision module configured to retrieve at least one historical option value corresponding to the user and the multiple option values, wherein the decision module further determines a determination result according to the multiple option values, the at least one historical option value, and at least one scenario criterion, and displays the determination result on the graphical interface of the interaction apparatus.

2. The electronic decision system as claimed in claim 1, wherein the interaction apparatus is a touch-sensitive screen.

3. The electronic decision system as claimed in claim 1, wherein the user further logs into the electronic decision system by a login module of the electronic decision system, thereby recognizing identity of the user.

4. The electronic decision system as claimed in claim 3, wherein the decision module further comprises:
an analyzing module configured to retrieve multiple option data and the at least one historical option value from the database according to the recognized identity of the user, and display the multiple option data on the graphical interface of the interaction apparatus; and
a resource optimization module configured to perform a resource optimization process on the multiple option values, the at least one historical option value and the at least one scenario criterion to determine the determination result.

5. The electronic decision system as claimed in claim 4, wherein the analyzing module further provides at least one option for preferred requirements which is selected by the user, wherein when the user selects the at least one option for preferred requirements, the resource optimization module further determines the determination result according to the multiple option values, the at least one historical option value, the at least one scenario criterion, and the at least one option for preferred requirements.

6. A decision method applied in an electronic decision system, comprising:
retrieving multiple option values of a user from a graphical interface displayed on an interaction apparatus of the electronic decision system;
retrieving at least one historical option value corresponding to the user and the multiple option values from a database;
determining a determination result according to the multiple option values, the at least one historical option value, and at least one scenario criterion; and
displaying the determination result on the graphical interface of the interaction apparatus.

7. The decision method as claimed in claim 6, wherein the interaction apparatus is a touch-sensitive screen.

8. The decision method as claimed in claim 6, wherein the user further logs into the electronic decision system by a login module of the electronic decision system, thereby recognizing identity of the user.

9. The decision method as claimed in claim 8, further comprising:
retrieving multiple option data and the at least one historical option value from the database according to the recognized identity of the user;
displaying the multiple option data on the graphical interface of the interaction apparatus; and
performing a resource optimization process to the multiple option values, the at least one historical option value, and the at least one scenario criterion to determine the determination result.

10. The decision method as claimed in claim 9, further comprising:
providing at least one option for preferred requirements which is selected by the user; and
determining the determination result according to the multiple option values, the at least one historical option value, the at least one scenario criterion, and the at least one option for preferred requirements when the user selects the at least one option for preferred requirements.
